(19) United States
(12) Patent Application Publication
(10) Pub. No.: US 2006/0232187 A1
(43) Pub. Date: Oct. 19, 2006

(54) Field emission light source and method for operating the same

(75) Inventors: Biing-Nan Lin, Hsinchu (TW); Cheng-Chung Lee, Hsinchu (TW); Yu-Yang Chang, Hsinchu (TW); Chun-Tao Lee, Hsinchu (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Industrial Technology Research Institute

(21) Appl. No.: 11/110,613

(22) Filed: Apr. 19, 2005

(51) Int. Cl. H01J 1/62; H01J 63/04

(52) U.S. Cl. 313/496; 313/497; 313/495

(57) ABSTRACT

A field emission device includes a first substrate, a second substrate spaced apart from the first substrate, a cathode structure formed between the first substrate and the second substrate for emitting electrons toward the second substrate, a luminescent layer formed between the first substrate and the second substrate for providing light when the electrons impinge thereon, and a reflecting layer formed between the second substrate and the luminescent layer for reflecting the light toward the first substrate.

### BACKGROUND OF THE INVENTION

The present invention relates generally to an electron emitting device, and more particularly to a field emission device to serve as a light source and a method for operating the field emission device.

In recent years, flat-panel display devices have been developed and widely used in electronic applications. Examples of flat-panel display devices include the liquid crystal display (“LCD”), plasma display panel (“PDP”) and field emission display (“FED”) devices. FEDs have received considerable attention as a next generation display device having the advantages of LCDs and PDPs. FEDs, which operate on the principle of field emission of electrons from microscopic tips, are known to be capable of overcoming some of the limitations and provides significant advantages over conventional LCDs and PDPs. For example, FEDs have higher contrast ratios, wider viewing angles, higher maximum brightness, lower power consumption, shorter response times and broader operating temperature ranges compared to conventional LCDs and PDPs. Consequently, FEDs are used in a wide variety of applications ranging from home televisions to industrial equipment and computers.

One of the most important differences between an FED and an LCD is that, unlike the LCD, the FED produces its own light source. The FED does not require complicated, power-consuming backlights and filters. Almost all light generated by an FED is viewed by a user. Thus, the costly light source of an LCD is eliminated. With the property of self-luminescence, a field emission device may function to serve as an independent light source rather than a display device. The principle of field emission of electrons is briefly discussed by reference to FIG. 1. FIG. 1 is a schematic diagram of a conventional field emission device 10. Referring to FIG. 1, field emission device 10, which functions to serve as a light source, includes a first substrate 12, a cathode assembly 14, a second substrate 22, a transparent electrode 24 and a phosphor layer 26. Cathode assembly 14 emits electrons, which are accelerated toward phosphor layer 26. Phosphor layer 26 provides luminescence when the emitted electrons collide with phosphor particles. Light provided from phosphor layer 26 transmits through transparent electrode 24, for example, an indium tin oxide (“ITO”) layer, and second substrate 22 to a display device (not shown), for example, an LCD device attached to second substrate 22. However, field emission device 10 may be disadvantageous in that the temperature at second substrate 22 is too high to adversely affect the performance or even lifetime of the attached display device.

### BRIEF SUMMARY OF THE INVENTION

The present invention is directed to a field emission device and a method for operating the field emission device that obviate one or more problems resulting from the limitations and disadvantages of the prior art.

In accordance with an embodiment of the present invention, there is provided a field emission device that comprises a first substrate, a second substrate spaced apart from the first substrate, a cathode structure formed between the first substrate and the second substrate for emitting electrons toward the second substrate, a luminescent layer formed between the first substrate and the second substrate for providing light when the electrons impinge thereon, and a reflecting layer formed between the second substrate and the luminescent layer for reflecting the light toward the first substrate.

Also in accordance with the present invention, there is provided a field emission display device that comprises a first substrate, a second substrate spaced apart from the first substrate, a first metal layer formed over the first substrate including first metal lines, a second metal layer formed over the first metal layer including second metal lines, emitters formed between the first metal layer and the second metal layer for emitting electrons toward the second substrate, a luminescent layer formed between the first substrate and the second substrate for providing light when the electrons impinge thereon, and a third metal layer formed between the second substrate and the luminescent layer for reflecting the light toward the first substrate.

Further in accordance with the present invention, there is provided a method of operating a field emission device that comprises providing a first substrate, providing a second substrate spaced apart from the first substrate, providing a cathode structure between the first substrate and the second substrate, providing a luminescent layer between the cathode structure and the second substrate, providing a reflecting layer between the luminescent layer and the second substrate, emitting electrons from the cathode structure toward the second substrate, radiating light from the luminescent layer, and reflecting the light from the reflecting layer toward the first substrate.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the present invention and together with the description, serves to explain the principles of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic diagram of a conventional field emission device;

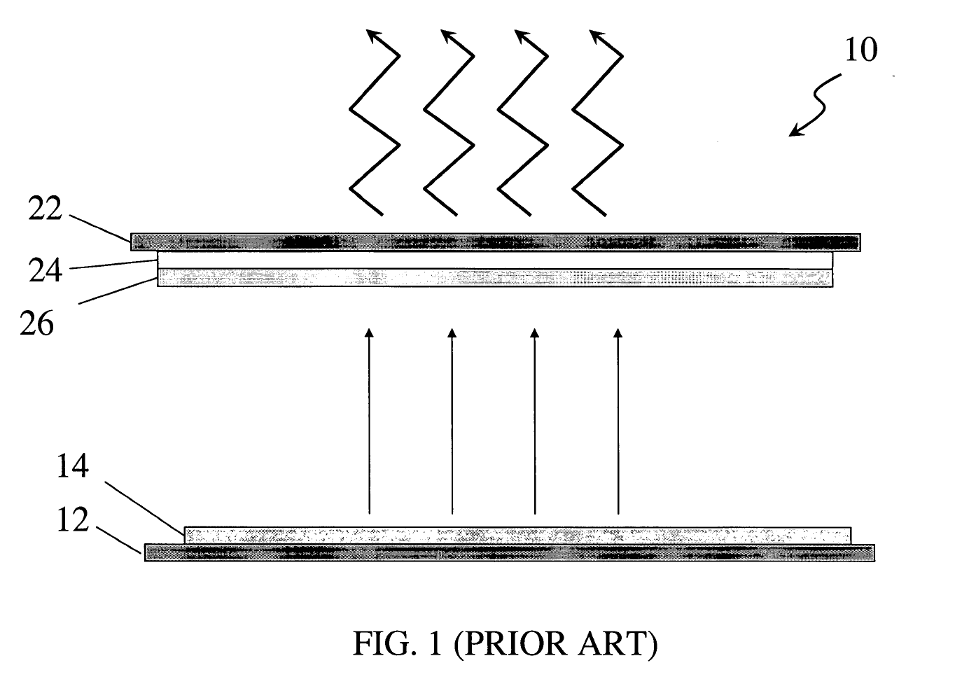

FIG. 2A is a schematic diagram of a field emission device in accordance with one embodiment of the present invention;

FIG. 2B is a schematic diagram of a luminescent layer of the field emission device shown in FIG. 2A; and

FIG. 2C is a schematic diagram of a cathode structure of the field emission device shown in FIG. 2A.

### DETAILED DESCRIPTION OF THE INVENTION

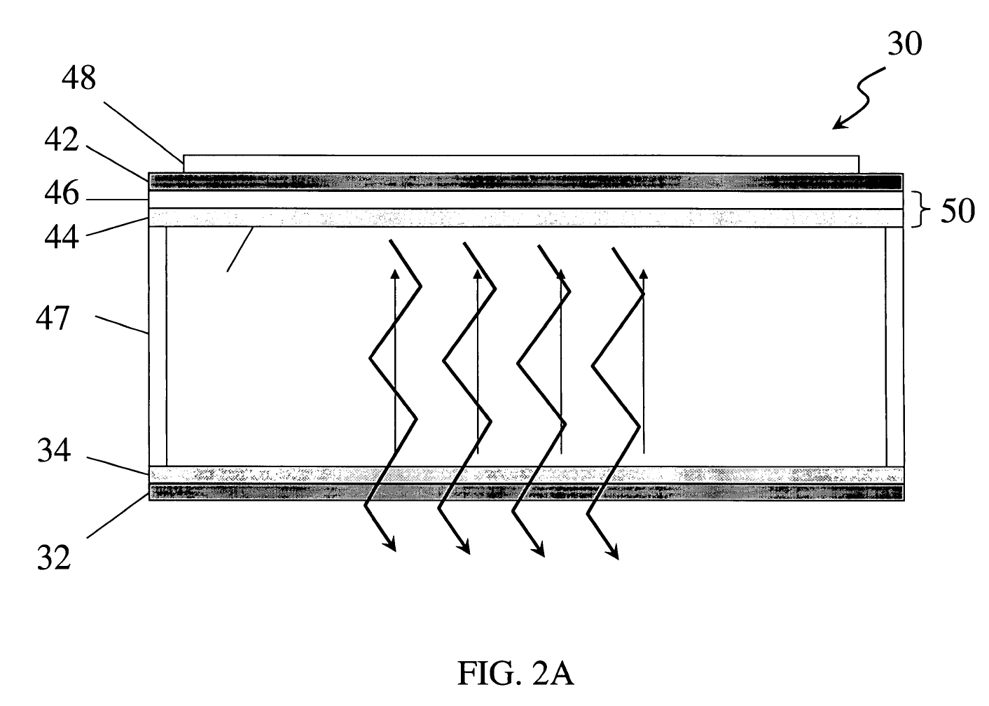

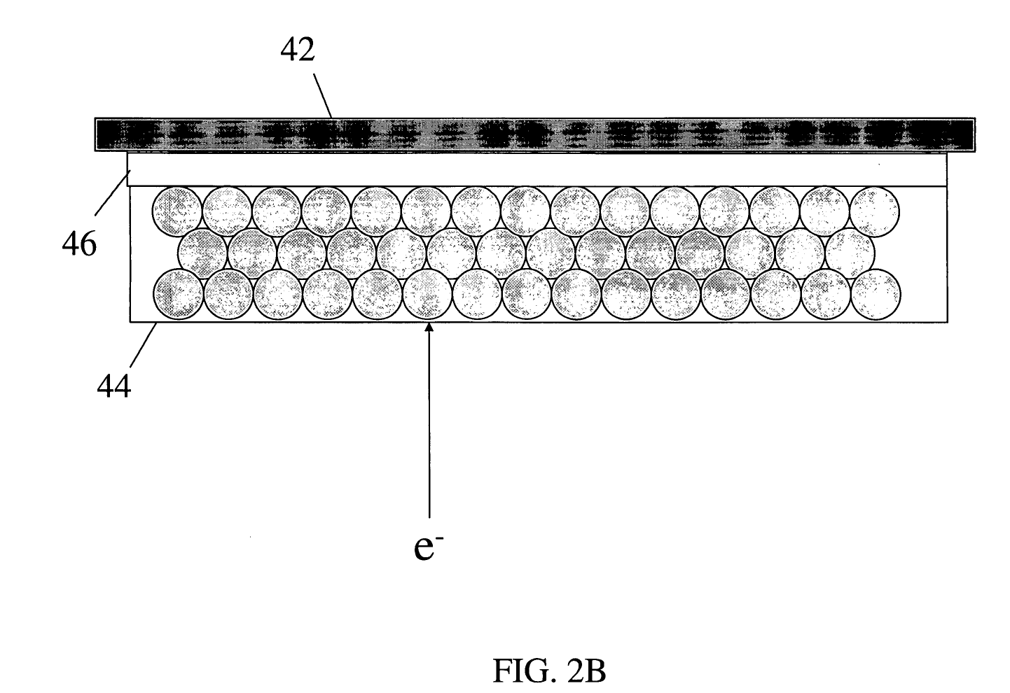

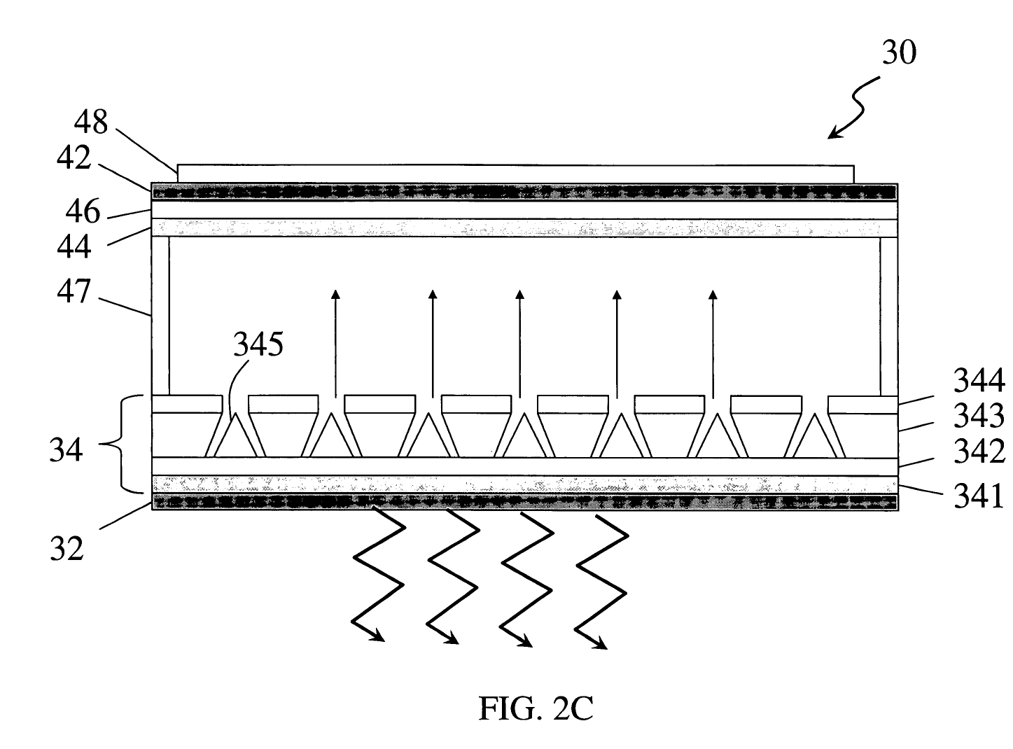

FIG. 2A is a schematic diagram of a field emission device 30 in accordance with one embodiment of the present invention. Referring to FIG. 2A, field emission device 30 includes a first substrate 32, a cathode structure 34, a second substrate 42, a reflecting layer 44, and a luminescent layer 46. Reflecting layer 44 and luminescent layer 46 are collectively called an “anode structure” 50. First substrate 32 and second substrate 42 are, for example, glass substrates. Cathode structure 34 functions to emit electrons toward luminescent layer 46, which in turn provides luminescence when the emitted electrons impinge thereon. Light generated from luminescent layer 46 is reflected by reflecting layer 44 toward first substrate 32, as indicated by arrow lines.

In one aspect of the present invention, field emission device 30 functions to serve as an independent light source. In another aspect, field emission device 30 serves as a light source for a display device, for example, a liquid crystal display (“LCD”) device (not shown). The display device is attached to first substrate 32 of field emission device 30 to receive the light emitted therefrom. The temperature at first substrate is substantially equal to room temperature, and therefore does not adversely affect the performance of the attached display device. Field emission device 30 may include a heat conductor 48, for example, a heat sink, attached to second substrate 42 for discharging excessive heat generated thereon.

Field emission device 30 may further include spacers 47 disposed between anode structure 50 and cathode structure 34 for maintaining a predetermined spacing therebetween. Spacers 47 are affixed to anode structure 50 and cathode structure 34 by using a glass fit sealant. An inter space region defined by anode structure 50, cathode structure 34 and spacers 47 may be maintained at a vacuum of approximately 10⁻⁶ Torr to 10⁻⁷ Torr to ensure continued accurate emission of electrons from cathode structure 34.

In addition to reflecting the light from luminescent layer 44, reflecting layer 46 also functions to serve as an electrode. In one embodiment according to the present invention, reflecting layer 46 includes a material selected from one of Al, TiO₂ or CoW. In another embodiment, reflecting layer 46 includes a metal material selected from one of Al, Ag, Pt, Au or Cu.

FIG. 2B is a schematic diagram of luminescent layer 44 of field emission device 30 shown in FIG. 2A. Referring to FIG. 2B, luminescent layer 44 includes three sub-layers (not numbered) of phosphor particles. The sub-layers of phosphor particles are formed on reflecting layer 46 by screen printing or spin coating. When the emitted electrons strike the phosphor particles, luminescent layer 44 emits light. The thickness of luminescent layer 44 is approximately 5 μm (micrometer). Also referring to FIG. 2A, each of first substrate 32 and second substrate 42 is approximately 1.1 to 2.8 mm (millimeter), cathode structure 34 is approximately 6 μm to 10 μm, and reflecting layer is approximately 0.3 μm to 0.5 μm in thickness. Moreover, heat conductor 48 is approximately 7 mm to 12 mm in thickness, and each of spacers 47 is approximately 1 mm to 4 mm in length.

FIG. 2C is a schematic diagram of cathode structure 34 of field emission device 30 shown in FIG. 2A. Referring to FIG. 2C, cathode structure 34 include a first metal layer 341, an insulating layer 343, a second metal layer 344 and emitters 345. First metal layer 341 includes first metal lines, which would serve as column lines if field emission device 30 were provided for display purpose. Second metal layer 344 includes second metal lines, which would serve as row lines. Since field emission device 30 functions to serve as a light source rather than a display device, the first metal lines and second metal lines are arranged to extend in substantially the same direction in order to enhance flux of the reflected light at first substrate 32.

First metal layer 341 is formed over first substrate 32 with a metal such as chromium (Cr). In one embodiment according to the present invention, a resistive layer 342 is formed over first metal layer 341 with an amorphous silicon in order to ensure uniform emission or electrons. Insulating layer 343, formed of a dielectric material such as SiO₂, and second metal layer 344 are deposited together, and are etched to form a plurality of wells (not numbered) arranged at regular intervals. Emitters 345 in the form of conical micro-tip formed of a metal such as molybdenum (Mo) are located in the wells. Emitters 345 may be formed by chemical vapor deposition (“CVD”), plasma-enhanced chemical vapor deposition (“PECVD”), or by other suitable chemical-physical deposition methods such as reactive sputtering, ion-beam sputtering, and dual ion beam sputtering.

Second metal layer 344 is electrically connected to a relatively positive voltage source, and first metal layer 341 is electrically connected to a relatively negative voltage source. Thus, as a voltage is applied across first metal layer 341 and second metal layer 344, electrons are emitted by emitters 345. The emitted electrons are accelerated toward reflecting layer 46, to which a voltage of, for example, several hundred to several thousand volts is applied. In one embodiment according to the present invention, the voltage levels of first metal layer 341 and second metal layer 344 are approximately 0 volts and 100 to 200 volts, respectively. Reflecting layer 46 is electrically connected to a power supply of approximately 1000 volts to 8000 volts.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A field emission device, comprising:
a first substrate;
a second substrate spaced apart from the first substrate;
a cathode structure formed between the first substrate and the second substrate for emitting electrons toward the second substrate;
a luminescent layer formed between the first substrate and the second substrate for providing light when the electrons impinge thereon; and
a reflecting layer formed between the second substrate and the luminescent layer for reflecting the light toward the first substrate.

2. The device of claim 1, further comprising a heat conductor attached to the second substrate.

3. The device of claim 1, wherein the reflecting layer includes one of Al, TiO₂ or CoW.

4. The device of claim 1, wherein the reflecting layer includes one of Al, Ag, Pt, Au or Cu.

5. The device of claim 1, wherein the first substrate is attached to a liquid crystal display device.

6. The device of claim 1, wherein the cathode structure includes a first metal layer comprising first metal lines and a second metal layer comprising second metal lines.

7. The device of claim 6, wherein the first metal lines and the second metal lines extend in a same direction.

8. The device of claim 6, wherein the cathode structure includes a resistive layer formed between the first metal layer and the second metal layer.

9. The device of claim 1, further comprising spacers to space the first substrate apart from the second substrate.

10. A field emission display device, comprising:
a first substrate;
a second substrate spaced apart from the first substrate;
a first metal layer formed over the first substrate including first metal lines;
a second metal layer formed over the first metal layer including second metal lines;
emitters formed between the first metal layer and the second metal layer for emitting electrons toward the second substrate;
a luminescent layer formed between the first substrate and the second substrate for providing light when the electrons impinge thereon; and
a third metal layer formed between the second substrate and the luminescent layer for reflecting the light toward the first substrate.

11. The device of claim 10, further comprising a heat conductor attached to the second substrate.

12. The device of claim 10, further comprising spacers to space the first substrate apart from the second substrate.

13. The device of claim 10, wherein the third metal layer includes one of Al, CoW, Ag, Pt, Au or Cu.

14. The device of claim 10, wherein the first metal lines and the second metal lines extend in a same direction.

15. The device of claim 10, further comprising a resistive layer formed between the first metal layer and the second metal layer.

16. A method of operating a field emission device, comprising:
providing a first substrate;
providing a second substrate spaced apart from the first substrate;
providing a cathode structure between the first substrate and the second substrate;
providing a luminescent layer between the cathode structure and the second substrate;
providing a reflecting layer between the luminescent layer and the second substrate;
emitting electrons from the cathode structure toward the second substrate;
radiating light from the luminescent layer; and
reflecting the light from the reflecting layer toward the first substrate.

17. The method of claim 16, further comprising attaching a heat conductor to the second substrate.

18. The method of claim 16, further comprising directing the light from the first substrate toward a liquid crystal display device.

19. The method of claim 16, wherein the reflecting layer includes one of Al, TiO₂ or CoW.

20. The method of claim 16, wherein the reflecting layer includes one of Al, Ag, Pt, Au or Cu.
